(19) United States
(12) Patent Application Publication
(10) Pub. No.: US 2001/0012573 A1
(43) Pub. Date: Aug. 9, 2001

(54) Magnetic recording medium, process for fabricating magnetic recording medium and information regenerator

(75) Inventors: Isatake Kaitsu, Higashine (JP); Hisateru Sato, Sendai (JP); Iwao Okamoto, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 09/733,501

(22) Filed: Dec. 8, 2000

(30) Foreign Application Priority Data
Jan. 20, 2000 (JP) 2000-014229

(51) Int. Cl. G11B 5/65

(52) U.S. Cl. 428/694 T

(57) ABSTRACT

A magnetic recording medium is provided which has ferromagnetic crystal grains having a uniform grain size which are successfully separated from each other. The magnetic recording medium comprises a non-magnetic substrate 1 and a recording layer 2 formed thereon, wherein the recording layer consists of at least one non-ferromagnetic material selected from the group consisting of non-magnetic materials and antiferromagnetic materials and a plurality of crystal grains 2_{—}1 made of ferromagnetic material solid-insoluble with the non-ferromagnetic material which are dispersed in the non-ferromagnetic material. The recording layer has at least two phases, along the depth direction, with each phase having a different mean composition ratio of the ferromagnetic material to the non-ferromagnetic material from that or those of the adjacent phase or phases.

### BACKGROUND OF THE INVENTION

1. Field of the Invention

The present invention relates to a magnetic recording medium on which information is magnetically recorded, a process for fabricating such magnetic recording medium, and an information regenerator which regenerates the information recorded on such magnetic recording medium.

2. Description of the Related Art

Current diffusion of computers has accelerated the increase in the amount of daily information to be dealt with. One exemplary device for recording and regenerating such a large amount of information commonly used today is a hard disk drive (HDD). HDD is typically provided with a built-in magnetic disk (or a disk-shaped magnetic recording medium on which information may be recorded) and a built-in magnetic head to record and regenerate information on and from the magnetic disk.

The magnetic disk has a recording layer containing a plurality of ferromagnetic crystal grains. The recording layer has a plurality of tracks, and each of these tracks contains a plurality of microregions (one-bit region). The magnetic disk retains magnetization independently for each of the one-bit regions. Once located adjacent to the magnetic disk, the magnetic head generates a magnetic field in response to an external signal current, and reverses the direction of magnetization in each of the one-bit regions when required, to record one-bit data in a one-bit region in a form of the direction of magnetization. Each one-bit region contains a number of the above-described ferromagnetic crystal grains. Accordingly, the term magnetization in one-bit region means the total sum of the magnetization of the crystal grains present in the one-bit region.

Recording density of a magnetic medium, or the amount of data which can be recorded on a magnetic disk as described above, has been improved from year to year, and there is still a strong demand for a magnetic disk which is easily re-writable with even higher recording density. Conventional magnetic disks are known, however, to have reduced S/Nₘ in regeneration signal of the recorded information (that is, medium noise Nₘ increases relative to the regeneration signal outputs) as the recording density of recorded information becomes higher, i.e., the above-described one-bit region becomes smaller. The medium noise hinders improvement of recording density.

Medium noise may be caused by two main reasons. One is variation of magnetization in magnetization-transit region. Magnetization-transit region is a region where the directions of magnetization transit with a certain width around the boundary between adjacent two one-bit regions which have opposite directions of magnetization. When strong magnetic interaction between the ferromagnetic crystal grains contained in the magnetization-transit region causes the directions of magnetization of these crystal grains to line up parallel to one another in each one-bit region, then smooth transition of magnetization may be difficult due to alternating magnetization, resulting in a wide range of variation in magnetization. As disclosed in JP-A-07-160437, however, when the magnetic disk is a granular medium which has a recording layer comprising a plurality of ferromagnetic crystal grains dispersed in non-magnetic material solid-insoluble with the ferromagnetic crystal grains, the magnetization will transit smoothly since the magnetic interaction between these crystal grains are substantially blocked, thereby reducing the variety of magnetization and medium noise.

The other reason which causes the medium noise is the variety of the grain sizes of crystal grains in the recording layer. Since regeneration signal output regenerated by the magnetic head is thought to be proportionate to the total sum of the volumes of the crystal grains in a one-bit cell, the wide range of the grain sizes of the crystal grains will increase the variety of the magnitudes of the magnetization in the individual one-bit regions even when such a granular medium is used, resulting in increased medium noise during regeneration output. Thus, it is required to reduce the above-described variety of grain sizes of the crystal grains.

As described in the above-described JP-A-7-160437, however, when the granular medium is produced by sputtering a non-magnetic material and a ferromagnetic material at the same time followed by heating, the ferromagnetic crystal grains in the granular medium will not be successfully separated from each other but rather some of the grains will contact with each other. Further, uniform grain size of the crystal grains will not be obtained.

Such unsuccessful separation and the variety of grains sizes of these crystal grains can be improved, as reported in “Toshiro Abe and Toshikazu Nishihara, Fe-SiO₂ granular metal medium, the 18^{th} Annual Meeting Review, The magnetic Society of Japan, 15aF-5, 437, 1994”, by applying a RF bias electric power to the substrate to form the recording layer. However, the granular medium produced by the process may also have undesirable incomplete separation and the varied grain sizes of ferromagnetic grains, requiring further improvement.

### SUMMARY OF THE INVENTION

In view oh the above, the object of the present invention is to provide a magnetic recording medium having a recording layer containing uniformly sized crystal grains which are successfully separated from each other, a process for fabricating such magnetic recording medium, and an information regenerator having the magnetic recording medium.

To accomplish the above-described object, the magnetic recording medium according to the present invention comprises a non-magnetic substrate and a recording layer formed thereon, wherein:

the recording layer consists of at least one non-ferromagnetic material selected from the group consisting of non-magnetic materials and antiferromagnetic materials and a plurality of crystal grains of ferromagnetic materials solid-insoluble with the non-ferromagnetic material which are dispersed in the non-ferromagnetic material; and

the recording layer has the composition ratio of said ferromagnetic material to the non-ferromagnetic material obtained by performing averaging at respective positions in the depth direction of the recording layer along the spreading direction there of varies in the depth direction in the recording layer.

The magnetic recording medium is a kind of granular medium which has a recording layer comprising a plurality of materials which are solid-insoluble with each other. When a granular medium is formed by sputtering or the like, one of a plurality of the materials which are solid-insoluble with each other (e.g., the ferromagnetic material in the present invention) may possibly be deposited as spherical crystal grains due to their own aggregating force. Thus deposited crystal grains are known to grow to have a grain size (critical grain size) predetermined for the process condition used, but larger size may be hardly attained. For the magnetic recording medium according to the present invention, the composition ratio of ferromagnetic material to non-ferromagnetic material can conveniently be considered the volume ratio of ferromagnetic material to non-ferromagnetic material since the ferromagnetic material is deposited as crystal grains, as described above.

Typically, conventional magnetic recording media have a constant mean composition ratio of ferromagnetic material to non-ferromagnetic material along the depth of the recording layer since the layer forming condition is not regulated during the process in which the recording layer comprising the ferromagnetic and non-ferromagnetic materials is formed. Such process may produce a number of fine ferromagnetic crystal grains at the early stage in the process and only portions of these fine crystal grains can grow to have the above-described critical grain size but others can not through the formation of the recording layer. As a result, the recording layer formed may contain both large crystal grains (i.e., crystal grains which have grown to have the critical grain size) and fine crystal grains (i.e., those which could not grow to the size). In the presence of crystal grains of different grain sizes, or the wide range of the crystal grain sizes, in the recording layer, larger crystal grains tend to be connected to each other via the fine crystal grain(s) intervening therebetween, thus making good separation of these crystal grains difficult. Such a wide range of grain sizes and unsuccessful separation of crystal grains may increase medium noise (i.e., noise caused by the medium) in the regeneration signal. Further, the presence of such fine crystal grains may reduce thermo-stability of record magnetization.

To the contrary, the magnetic recording medium according to the present invention has a composition ratio of the ferromagnetic material to the non-ferromagnetic material obtained by performing averaging at respective position in the depth direction along the spreading direction there of varies in the depth direction in the recording medium. The recording layer of the magnetic recording medium according to the present invention, which contains a plurality of uniformly sized crystal grains that are successfully separated from each other and is almost free of such fine crystal grains, can be obtained by changing, in at least two stages, the composition ratio depending on the growing state of the crystal grains which will be developed to have the critical grain size. Thus, this magnetic recording medium is almost free of medium noise by the virtue of the uniform grain size and successful separation of the crystal grains, and can provide thermo-stable record magnetization due to absence of fine crystal grains.

Preferably, the magnetic recording medium according to the present invention has a lower composition ratio on the side of the recording layer facing the substrate, and the ratio is increased to a predetermined first height from the side.

The composition ratio in the recording layer of magnetic recording medium may be preferably decreased from the predetermined first height to a predetermined second height.

The number of crystal nuclei formed on the substrate can be reduced by reducing the composition ratio of ferromagnetic material to non-magnetic material at the early stage in the process of forming the recording layer. Then, almost all of the above-described crystal nuclei can be grown as large as possible without producing undesirable excess fine crystal grains by sequentially increasing the above-described composition ratio until the recording layer are formed to a first height, e.g., a height almost equal to a half of the above-described critical grain size, and then sequentially decreasing the composition ratio to a second height, e.g., a height almost equal to the critical grain size.

The magnetic recording medium may preferably have repeated increase and decrease in the composition ratio along the depth direction.

The recording layer may have additional layer or layers of the above-described crystal grains stacked on the first layer of the grains. For stacking another layer of the grains, the recording layer can be formed without producing excess fine crystal grains by repeating increase and decrease in the composition ratio along the depth direction.

Preferably, the ferromagnetic material to be used in the above-described magnetic recording medium according the present invention may be an alloy comprising Co and Pt, and the non-ferromagnetic material may be oxide.

To accomplish the above-described object, the present invention provides a process for fabricating magnetic recording medium comprising a non-magnetic substrate and a recording layer formed thereon wherein the recording layer comprises at least one non-ferromagnetic material selected from the group consisting of non-magnetic materials and antiferromagnetic materials and a plurality of ferromagnetic crystal grains solid-insoluble with the non-ferromagnetic material which are dispersed in the non-ferromagnetic material by depositing the recording layer on the substrate while changing the composition ratio of the ferromagnetic material to non-ferromagnetic material.

The process for fabricating magnetic recording medium involves depositing the recording layer while varying the above-described composition ratio as described. By controlling the composition ratio for each of the phases in the recording layer depending on the growing state of the crystal grains at the phase, the recording layer containing a plurality of uniformly sized crystal grains which are suitably spaced from each other can be obtained without producing the above, described excess fine crystal gains. Thus, the magnetic recording medium produced by the process may hardly generate medium noise and can provide thermo-stability of record magnetization.

When a recording layer is formed by, for example, sputtering, the formation of the recording layer with varies composition may be accomplished by providing a target of the above-described ferromagnetic material and another target of the above-described non-ferromagnetic material, and then changing the electric powers applied to the respective targets with time.

The above-described process for fabricating magnetic recording medium according the present invention may preferably involve of increasing the above-described composition ratio from the small value on the side of the recording layer facing the substrate to a first height to form the recording layer on the substrate.

Preferably, this process for fabricating magnetic recording medium may also involve decreasing the above-described composition ratio from the first height to a second height to form the recording layer on the substrate.

The process for fabricating magnetic recording medium according to the present invention may involve repeating the increase and decrease in the above-described composition ratio to form the recording layer on the substrate.

The above-described process for fabricating magnetic recording medium according to the present invention may involve applying a RF bias to the substrate during formation of the recording layer.

Such application of a RF bias to the substrate may promote the growth of the crystal grains in the recording layer and thus facilitate formation of uniformly sized crystal grains.

The above-described information regenerator according to the present invention comprises a magnetic recording medium on which information is recorded by magnetization and a magnetic head which is located in the vicinity of or in contact with the magnetic recording medium to detect magnetization at each point on the magnetic recording medium for regenerating information according to the magnetization detected by the magnetic head, wherein:

the magnetic recording medium comprises a non-magnetic substrate and a recording layer formed thereon, said recording layer being composed of at least one non-ferromagnetic material selected from the group consisting of non-magnetic materials and antiferromagnetic materials and a plurality of crystal grains of ferromagnetic material solid-insoluble with the non-ferromagnetic material which are dispersed in the non-ferromagnetic material; and

the recording layer has the composition ratio of said ferromagnetic material to the non-ferromagnetic material obtained by performing averaging at respective position in the depth direction of the recording medium along the spreading direction there of varies in the depth direction in the recording medium.

The magnetic recording medium of the information regenerator which corresponds to the above-described magnetic recording medium according to the present invention may produce little medium noise and thus provide good regeneration of the information recorded on the magnetic recording medium.

Hereinafter the present invention will be described in detail by referring to embodiments and drawings.

### BRIEF DESCRIPTION OF THE DRAWINGS

FIGS. 1 shows a schematic view of the hard disk drive according to the embodiment of the present invention.

FIG. 2 shows a cross sectional view of an exemplary magnetic disk which constitutes the hard disk drive of FIG. 1.

FIG. 3 shows a cross sectional view of a conventional magnetic disk.

FIG. 4 shows a schematic view of a RF magnetron sputtering device to be used for fabricating the magnetic disk according to the embodiment of the present invention.

### DETAILED DESCRIPTION OF THE PREFERRED EMBODIMENT

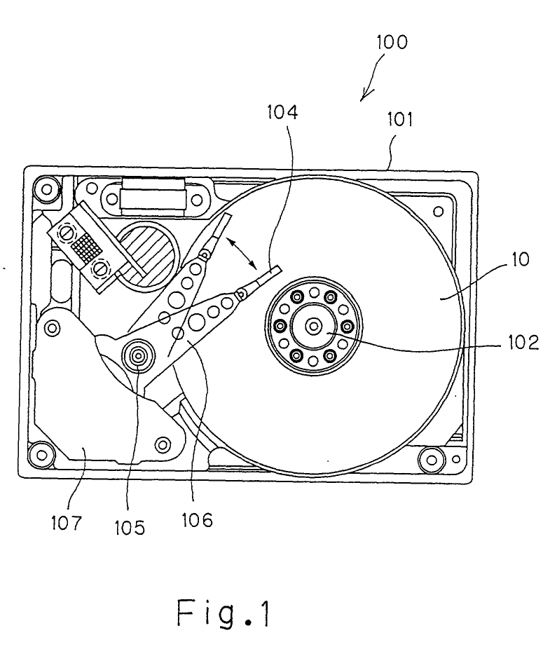

FIG. 1 shows a schematic view of the hard disk drive according to the embodiment of the present invention.

The hard disk drive (HDD) 100 shown in FIG. 1 corresponds to the information regenerator according to the present invention. The HDD100 comprises a housing 101, a rotating spindle 102, a magnetic disk 10 fixed on the rotating spindle 102, a floating head slider 104 which faces and adjacent to the surface of the magnetic disk 10, an arm spindle 105, a carriage arm 106 which has the floating head slider 104 fixed to the tip thereof and pivots around the arm spindle 105 to move horizontally on the magnetic disk 103, and an actuator 107 which drives the horizontal movement of the carriage arm 106, wherein the housing 101 accommodates all other elements described above.

The HDD 100 records information on the magnetic disk 10 and regenerates the information recorded on the magnetic disk 10. For recording and regenerating information, at first, actuator 107 comprising magnetic circuits drives carriage arm 106 which in turn locates floating head slider 104 on a desired track on the magnetic disk 10. The head slider 104 has a magnetic head (not shown in FIG. 1) provided thereon. The magnetic head is located on the magnetic disk 10 sequentially adjacent to each one-bit region arranged in each track on the magnetic disk 10 by rotation of the magnetic disk 10. For recording information, an electric recording signal is transmitted to the magnetic head located adjacent to the magnetic disk 10, the magnetic head in turn applies a magnetic field to each of these one-bit regions in response to the recording signal, and the data carried on the recording signal is then recorded in a form of the direction of magnetization in each one-bit region. For regenerating information, the data recorded in a form of the direction of magnetization in each one-bit region is retrieved as an electric regeneration signal produced in response to the magnetic field generated from the magnetization by means of the magnetic head. Internal space of the housing 101 is enclosed by a cover (not shown).

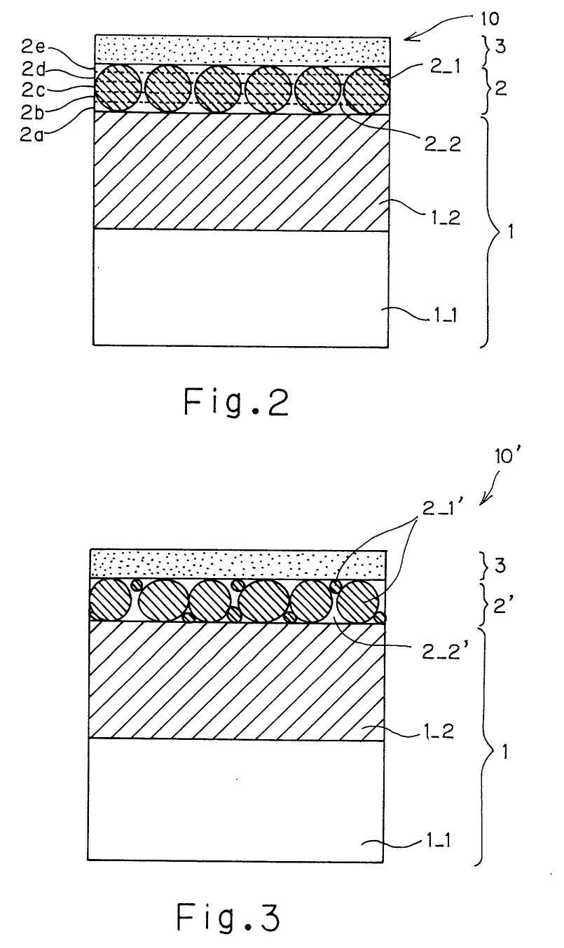

FIG. 2 shows a cross sectional view of an exemplary magnetic disk which constitutes the hard disk drive of FIG. 1.

The magnetic disk 10, of which sectional view is shown in FIG. 2, corresponds to the magnetic recording medium according to the present invention. The magnetic disk 10 comprises: a substrate 1 consisting of an aluminum disk 1_1 and an NiP coating layer 1_2 coated on the aluminum disk 1_1; a recording layer 2 which comprises non-magnetic SiO₂ matrix 2_2 and a plurality of crystal grains 2_1 of ferromagnetic Co₈₀Pt₂₀ (atomic %) dispersed in the SiO₂ matrix 2_2 and has five phases (a first layer 2a, a second layer 2b, a third layer 2c, a fourth layer 2d, and a fifth layer 2e from the side adjacent to the substrate 1) formed on the NiP coating layer 1_2 coated on the substrate 1 wherein the crystal grains have been grown across through these five phases; and a protecting layer 3 consisting of hard carbon which is formed on the recording layer 2 for protection. The recording layer 2 is 20 nm thick while the protecting layer 3 is 10 nm thick. The information recorded on the magnetic disk 10 is carried by magnetization of the crystal grains 2_1.

Co₈₀Pt₂₀ which constitutes the crystal grains 2_1 is a ferromagnetic hexagonal crystal alloy which has a crystalline magnetic uniaxial anisotropy. Such Co alloys provide a desirable high coercive force (from about 160 kA/m to about 400 kA/m) so as to keep good magnetization of the recording layer 2. Co alloys also have uniaxial anisotropy to provide high thermo-stability of recording magnetization. Thus, Co alloys can preferably be used as the ferromagnetic material in the recording layer 2. More preferably, CoPt alloys which comprises Co added with Pt may be used as the above-described ferromagnetic materials since adding Pt may improve the coercive force of Co.

Crystal grains 2_1 composed of the alloy tend to be deposited in a spherical form due to its own aggregating force in the recording layer 2 since crystal grains 2_1 (metal) and SiO₂ matrix 2_2 (oxide) are not solid-insoluble with each other. The crystal grains 2_1 are formed by growing small particles during the formation of the recording layer 2 by, for example, sputtering. Such crystal grains are known to grow to have a grain size predetermined for the process condition to be used (critical grain size) though larger size may hardly be attained.

As described above, the recording layer 2 has 5 phases each of which has a different composition ratio of ferromagnetic Co₈₀Pt₂₀ to non-magnetic SiO₂ from that or those of the adjacent phase or phases. In the magnetic disk 10, the above-described composition is substantially represented as the volume ratio of crystal grains 2_1 to SiO₂ matrix 2_2 for each phase since Co₈₀Pt₂₀ and SiO₂ are solid insoluble with and thus separated from each other. Thus, difference of the composition ratio among these phases are represented as the difference in volume percentages of SiO₂ matrix 2_2 and crystal grains 2_1 in each phase, as shown in Table 1.

TABLE 1

| | | Volume percentage | Volume percentage |
|---|---|---|---|
| | Thickness | (vol %) | (vol %) |
| | (nm) | Co₈₀Pt₂₀ | SiO₂ |
| First phase | 4 | 20 | 80 |
| Second phase | 4 | 40 | 60 |
| Third phase | 4 | 60 | 40 |
| Fourth phase | 4 | 40 | 60 |
| Fifth phase | 4 | 20 | 80 |

Table 1 shows the thickness, the volume percentage of Co₈₀Pt₂₀ crystal grains 2_1 (vol %) in the recording layer 2, and volume percentage of SiO₂ matrix 2_2 (vol %) in the recording layer 2 in each of phases 1-5 (leftmost column). As shown in Table 1, each phase is 4 nm thick.

The volume percentage of crystal grains 2_1 in the recording layer 2 is as low as 20 vol % in the first phase laminated directly on the substrate 1 and the second and third phases have successively increased volume percentages (40 vol % and 60 vol %, respectively) while the fourth and fifth phases have successively decreased volume percentages (40 vol % and 20 vol %, respectively). To the contrary, the volume percentage Of SiO₂ matrix 2_2 is as high as 80 vol % in the first phase and the second and third phases have successively decreased volume percentages (60 vol % and 40 vol %, respectively) while the fourth and fifth phases have successively increased volume percentages (60 vol % and 80 vol %, respectively).

The magnetic disk 10 according to the present embodiment has five phases each of which has a different volume percentage of crystal grains 2_1 in the recording layer 2. In other words, the mean composition ratio of ferromagnetic Co₈₀Pt₂₀ to non-magnetic SiO₂ for each phase will sequentially change along the depth direction. This configuration allows these crystal grains 2_1 to have a uniform grain size in the recording layer 2 to be successfully separated from each other as shown in FIG. 2, as will be described below.

For comparison, the configuration of a conventional magnetic disk will be hereinafter described. At the same time, a process for fabricating the magnetic disk 10 according to the present embodiment and the growth process of crystal grains 2_1 will be described as well. Then the reason will be explained why crystal grains 2_1 have a uniform grain size and are suitably separated from each other.

FIG. 3 shows a cross sectional view of a conventional magnetic disk.

As shown in FIG. 3, the conventional magnetic disk 10′ comprises: the same type of substrate 1 as that of the magnetic disk 10 according to the above-described embodiment; a conventional recording layer 2′ formed on the substrate 1; and the same type of protection layer 3 as that of the magnetic disk 10 according to the above-described embodiment.

The conventional recording layer 2′ comprises, as the recording layer 2 of the magnetic disk 10 according to the present embodiment, SiO₂ matrix 2_2′ and crystal grains 2_1 of Co₈₀Pt₂₀ dispersed into the SiO₂ matrix 2_2′ in a form of spherical deposition. Unlike the magnetic disk 10 according to the present embodiment, however, the conventional recording layer 2′ has crystal grains 2_1′ of various grain sizes. In the presence of the variety of grain size or a size dispersion of crystal grains 2_1′ in the recording layer 2′, larger crystal grains tend to be connected to each other via fine crystal grain(s) intervening therebetween, thus making good separation of these crystal grains difficult. Such increased dispersion of grain size and insufficient separation of crystal grains may increase medium noise in the regeneration signal of the information carried by magnetization of the conventional magnetic disk 10′. Further, the presence of such fine crystal grains may reduce thermo-stability of record magnetization.

To the contrary, the recording layer 2 in the magnetic disk 10 according to the present embodiment contains a plurality of crystal grains 2_1 having a uniform grain size which are suitably separated from each other, and is almost free of such fine crystal grains as those contained in the conventional recording layer 2′. Thus, the magnetic disk 10 according to the present embodiment may provide thermo-stable record magnetization, substantially without generating medium noise.

Next, a process for fabricating the magnetic disk 10 according to the present embodiment will be described below.

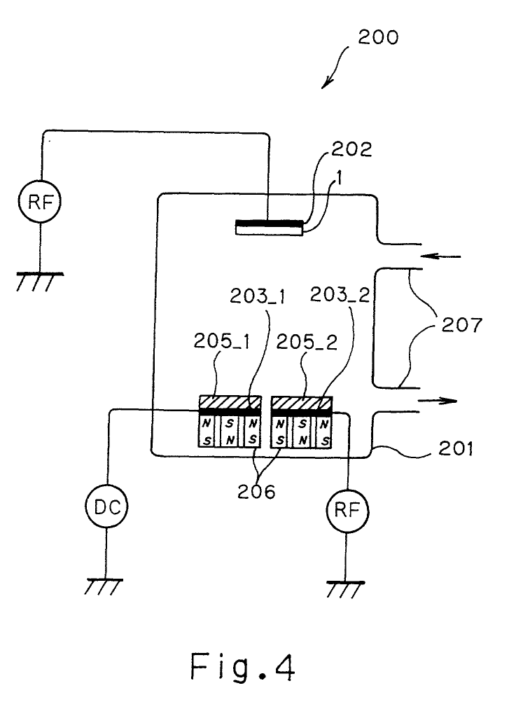

FIG. 4 shows a schematic view of a RF magnetron sputtering device to be used for fabricating the magnetic disk according to the present embodiment of the present invention.

The sputtering device 200 shown in FIG. 4 comprises: a vacuum housing 201; an electrode 202 provided in the upper region within the vacuum housing 201 which can apply a high-frequency AC voltage when required; and electrodes 203_1 and 203_2 provided in the lower portion within the vacuum housing 201 to be applied DC voltage and high-frequency AC voltage, respectively. The upper electrode 202 is provided with the above-described substrate 1 comprising an aluminum disk and NiP coating layer provided thereon. The two lower electrodes 203_1 and 203_2 are provided with targets 205_1 of Co₈₀Pt₂₀ and 205_2 of SiO₂, respectively. These electrodes 203_1 and 203_2 are also provided each with two magnets 206. The vacuum housing 201 is connected with a gas pipe 207 through which gases are introduced or exhausted. Inert Ar gas may be introduced through the pipe 207. Pressure of the Ar gas may be kept at 0.7Pa within the gas pipe 207.

In the sputtering device 200, when a voltage is applied to the above-described target electrodes, Ar gas in the vacuum housing 201 becomes to be in the high-density plasma state. Ionized Ar molecules in the plasma are accelerated to collide with the targets to knock-on atoms out of the materials constituting the targets. These atoms may then attach to the substrate 1 to form a thin film depending on the material of the target.

When the above-described recording layer 2 is formed on the substrate 1 by the sputtering device 200, the respective cathode electric powers which are simultaneously applied to the targets 205_1 of Co₈₀Pt₂₀ and 205_2 of SiO₂ individually will not be kept constant during formation of the recording layer 2 but rather sequentially changed in each of steps 1-5, for example, as shown in Table 2.

TABLE 2

| | Cathode Electric | Cathode Electric |
|---|---|---|
| | Power (W) Applied to | Power (W) Applied to |
| | Co₈₀Pt₂₀ | SiO₂ |
| Step 1 | 30 | 200 |
| Step 2 | 50 | 150 |
| Step 3 | 70 | 100 |
| Step 4 | 50 | 150 |
| Step 5 | 30 | 200 |

The table 2 shows the cathode electric power applied to either Co₈₀Pt₂₀ target 205_1 or SiO₂ target 205_2 for each of steps 1-5 (leftmost column) five steps in the process of forming the recording layer 2.

As shown in Table 2, the cathode electric powers applied to Co₈₀Pt₂₀ target 205_1 are 30W, 50W, 70W, 50W and 30W in steps 1-5, respectively, in the process of forming the recording layer 2 on the substrate 1, i.e., the electric power applied is controlled so as to be sequentially increased from step 1 to step 3 and then sequentially decreased from step 3 to step 5. To the contrary, the cathode electric powers applied to SiO₂ target 205_2 are 200W, 150W, 100W, 150W and 200W in steps 1-5, respectively, i.e., the electric power applied is controlled so as to be sequentially decreased from step 1 to step 3 and then sequentially increased from step 3 to step 5.

Thus, a recording layer 2 or CoPt-SiO₂ composite film is formed on substrate 1. For forming the film, 0.25W/cm² RF bias electric power is applied to the electrode 202 on which substrate 1 is provided. The application of the RF bias electric power promotes the growth of Co₈₀Pt₂₀ crystal grains 2_1 in the CoPt-SiO₂ composite film, thereby facilitating formation of crystal grains 2_1 having a uniform large grain size. When such a composite film is formed RF bias may not necessarily be applied to the substrate 1 though it may preferably be applied for obtaining more suitable magnetic disk for high-density recording.

The sputter device 200 is provided with an electrode (not shown) to which DC voltage is applied in the lower space within the vacuum housing 201. A carbon target (not shown) is provided on the electrode. The electrode is also provided with magnet (not shown).

Sputtering is performed by applying DC cathode electric power to the target to form a protecting layer 3 consisting of carbon on the recording film 2 laminated on the substrate 1. When the protecting layer 3 is formed, a RF bias electric power will not be applied to the electrode 202 on which the substrate 1 is provided. Production process of magnetic disk 10 is completed with the lamination of the protecting layer 3.

When recording layer 2 is formed in the process for fabricating magnetic disk 10, the cathode electric power applied is successively changed at five phases as described above. Generally, as the cathode electric power applied to the target increase, the amount of atoms to be deposited on the substrate from the target will increase. Therefore, the recording layer 2 has 5 phases with each having a different composition ratio of Co₈₀Pt₂₀ to SiO₂ from that or those of the adjacent phase or phases.

On the other hand, for producing a conventional type of magnetic disk 10′, the respective electric powers applied to Co₈₀Pt₂₀ target 205_1 and SiO₂ target 205_2 are typically constant during formation of the above-described recording layer 2′. Therefore, the recording layer 2′ has a uniform composition ratio of Co₈₀Pt₂₀ to SiO₂ along the depth direction of the layer.

For forming the recording layer 2′ having such a uniform composition ratio along the depth of the layer, a number of fine crystal grains are formed in early step, and only portions of these fine crystal grains will grow to have the above-described critical grain size. In the first half of the process where the formation process of recording layer 2′ proceeds until the layer has a thickness almost equal to a half of the critical grain size, materials for crystal grains supplied from the target to the substrate 1 may be used for the growth of portions of crystal grains which will grow to have the above-described grain size, resulting in shortage of the material to stop of the growth of the rest (fine crystal grains). In the last half of the process during which recording layer 2′ develops from the height almost equal to a half of the critical grain size to another height almost the same as the critical grain size, the amount of materials necessary for growth of crystal grains to grow to have the critical grain size is gradually reduced so that additional fine crystal grains may thus be produced from the excess materials. As a result, the recording layer 2′ may contain both larger crystal grains which are almost equal to the critical grain size and fine crystal grains which are smaller than the critical grain size.

In the presence of the variety of grain size or a size dispersion of the crystal grains in the recording layer, crystal grains having the critical grain size tend to be connected to each other via such fine crystal grains intervening therebetween, thereby making successful separation of these large crystal grains difficult. As described above, such increased dispersion of grain size or unsuccessful separation of crystal grains 2_1′ will increase medium noise, i.e., noise due to a medium in regenerated signals as described above. Moreover, the presence of such fine crystal grains may reduce thermo-stability of record magnetization.

To the contrary, the magnetic disk 10 in the above-described composition has varied composition ratios of the ferromagnetic CoPt to the non-magnetic SiO₂ along the depth direction. By controlling the composition ratio for each of the phases in the recording layer 2 so as to be suitable for the growth of the crystal grains 2_1 in the phase as described above (i.e., by controlling composition ratio so as to be suitable for the diameter of crystal grains 2_1 formed at the stage in the recording layer 2), the recording layer 2 can have a plurality of uniformly sized crystal grains 2_1 which are suitably spaced from each other, substantially free of fine crystal gains.

More particularly, the number of crystal nuclei of CoPt can be reduced by reducing the composition ratio of CoPt (a ferromagnetic material) to SiO₂ (a non-magnetic material) at early stage in the process of forming the recording layer 2. Then, almost all of the above-described crystal nuclei can be sufficiently grown to have a large grain size without producing undesirable fine crystal grains by sequentially increasing the above-described composition ratio until the recording layer 2 are formed to a height almost equal to a half of the above-described critical grain size, and then sequentially decreasing the composition ratio until the recording layer 2 is formed to another height almost equal to the critical grain size.

The magnetic disk 10 having recording layer 2 obtained as described above will be almost free of medium noise and have thermo-stable recording magnetization.

Alternatively, additional layer of layers of the crystal grains 2_1 may be stacked on the first layer of the crystal grains 2_1 in the recording layer 2. For stacking layer(s) or the crystal grains, the recording layer 2 may be formed without producing fine crystal grains by repeating increase and decrease in the composition ratio along the depth direction.

Although the recording layer 2 has 5 phases with each phase having a different ratio in the above-described composition from that or those of the adjacent phase or phases according to the present embodiment, it may have 2-4 phases or 6 phases or more. It should be noted that it is more preferable to form the recording layer 2 by sequentially reducing and increasing the composition ratio depending on the growth of the crystal grains 2_1.

Although Co₈₀Pt₂₀ is employed as the ferromagnetic material in the present embodiment, any other CoPt alloys may be used which have other composition than Co₈₀Pt₂₀. Alternatively, any ferromagnetic material other than CoPt may be used.

Although SiO₂ is employed as the non-magnetic material for recording layer 2 in the above-described composition, any other materials can be used provided that the materials are stable at room temperature under atmospheric pressure. More preferably, the material may have low solid-solubility with the ferromagnetic material to be used. Preferable examples of such non-magnetic materials are: metals such as gold, silver and copper; oxides such as SiO₂, Zr₂O₃ and Al₂O₃; nitrides such as SiN and TiN; and light elements such as carbon. Antiferromagnetic materials such as NiO and CoO may also be employed instead of non-magnetic materials as the matrix for separating the ferromagnetic crystal grains in the recording layer 2.

As described above, the present invention can provide a magnetic recording medium containing uniformly sized ferromagnetic crystal grains which are suitably separated from each other, a process for fabricating the magnetic recording medium, and an information regenerator which employs the magnetic recording medium to provide high S/Nₘ ratio in regenerated signals.

What is claimed is:

1. A magnetic recording medium which comprises a non-magnetic substrate and a recording layer on the non-magnetic substrate, where
said recording layer comprises at least one non-ferromagnetic material selected from the group consisting of non-magnetic materials and antiferromagnetic materials and a plurality of crystal grains of ferromagnetic material solid-insoluble with said non-ferromagnetic material which are dispersed in said at least one non-ferromagnetic material, wherein
a composition ratio of said ferromagnetic material to the non-ferromagnetic material obtained by performing averaging at respective position in the depth of the recording layer along spreading direction thereof varies in the depth direction in the recording layer.

2. The magnetic recording medium according to claim 1 wherein said composition ratio in said recording layer is smaller on the side of the recording layer adjacent to said substrate and increases from said side to a first predetermined height.

3. The magnetic recording medium according to claim 2 wherein said composition ratio decreases from said first predetermined position to a second predetermined height in the recording layer.

4. The magnetic recording medium according to claim 3 wherein said composition is repeatedly increased and decreased along the depth direction in said recording layer.

5. The magnetic recording medium according to claim 1 wherein said ferromagnetic material is an alloy comprising Co and Pt.

6. The magnetic recording medium according to claim 1 wherein said non-ferromagnetic material is an oxide.

7. A process for fabricating magnetic recording medium comprising a non-magnetic substrate and a recording layer formed thereon wherein said recording layer comprises at least one non-ferromagnetic material selected from the group consisting of non-magnetic materials and antiferromagnetic materials and a plurality of ferromagnetic crystal grains solid-insoluble with said at least one non-ferromagnetic material which are dispersed in the non-ferromagnetic material, wherein
said process comprising the step of depositing the recording layer on the substrate while changing the composition ratio of the ferromagnetic material to non-ferromagnetic material.

8. A process for fabricating magnetic recording medium wherein a RF bias is applied to said substrate during the formation of said recording layer.

9. An information regenerator comprising a magnetic recording medium on which information is recorded by magnetization and a magnetic head which is located in the vicinity of or in contact with said magnetic recording medium to detect magnetization at each point on said magnetic recording medium for regenerating said magnetization detected by said magnetic head, wherein:
said magnetic recording medium comprises a non-magnetic substrate and a recording layer formed thereon, said recording layer being composed of at least one non-ferromagnetic material selected from the group consisting of non-magnetic materials and antiferromagnetic materials and a plurality of crystal grains of ferromagnetic material solid-insoluble with said non-ferromagnetic material which are dispersed in said at least one non-ferromagnetic material; and
said recording layer has at least two phases, along the depth direction, with each phase having a different mean composition ratio of the ferromagnetic material to the non-ferromagnetic material from that or those of the adjacent phase or phases.
